(19) United States
(12) Patent Application Publication
(10) Pub. No.: US 2013/0297360 A1
(43) Pub. Date: Nov. 7, 2013

(54) FLIGHT-PRICE MONITORING SYSTEMS AND METHODS

(71) Applicants: Russell BARBER, Bellevue, WA (US); Chris BOUZEK, Bellevue, WA (US); Karim MEGHJI, Redmond, WA (US); Stephen MULLINS, Seattle, WA (US); Megan SCHNEIDER, Seattle, WA (US)

(72) Inventors: Russell BARBER, Bellevue, WA (US); Chris BOUZEK, Bellevue, WA (US); Karim MEGHJI, Redmond, WA (US); Stephen MULLINS, Seattle, WA (US); Megan SCHNEIDER, Seattle, WA (US)

(73) Assignee: YAPTA, INC, Seattle, WA (US)

(21) Appl. No.: 13/888,991

(22) Filed: May 7, 2013

Related U.S. Application Data
(60) Provisional application No. 61/643,850, filed on May 7, 2012.

(51) Int. Cl. G06Q 10/02

(52) U.S. Cl. CPC G06Q 10/025
USPC 705/6

(57) ABSTRACT

A flight-ticket price may be monitored by obtaining an itinerary record associated with a previously-booked flight itinerary, identifying a group of flight segments that corresponds to a ticket, “fingerprinting” the ticket, and determining a schedule to periodically monitor prices associated with the ticket. During at least one price-monitoring period, an up-to-date version of the itinerary record is obtained and “fingerprinted”. The “fingerprints” are used to verify that the flight ticket has not changed significantly, current pricing data is obtained, and a cost saving is determined to be currently obtainable, considering possible change penalties, by re-ticketing or re-booking the group of flight segments.

### FIELD

This disclosure is directed to computer-based price monitoring. More particularly, this disclosure is directed to post-purchase price-monitoring for goods or services such as airline flights that are commonly purchased in advance and whose prices exhibit high volatility.

### BACKGROUND

As in most industries, modern airlines typically price their services in an attempt to maximize profitability. The pricing of airline tickets has become increasingly complicated and is commonly determined by computerized yield management systems.

Many airlines use differentiated pricing schemes to simultaneously sell air services at varying prices to different segments. Factors influencing the price frequently include the days remaining until departure, the booked load factor, the forecast of total demand by price point, competitive pricing in force, variations by day of week and/or by time of day, and the like.

Moreover, carriers often segment airfares into multiple travel classes for pricing purposes. Such travel classes are often represented by a “class code” or reservations/booking designator such as “F” and “P” for first class and first class premium, “C” and “J” for business and business premium, “Y” for economy/coach, and so on. With the advent of cheaper fares and more frequent travel, there may be dozens of available travel classes, with a corresponding number of class codes to differentiate between them.

Since the late 1970s, computerized reservations systems (“CRS”) have been used by airlines and travel agencies to store and retrieve information and conduct transactions related to air travel. Large CRS operations that book and sell tickets for multiple airlines are also known as global distribution systems (“GDS”). In addition to airline tickets, some modern computerized reservations systems also allow users to book other travel-related services, such as hotel rooms and rental cars. Examples of major computerized reservations systems include Sabre Global Distribution System, provided by Sabre Holdings Corporation of Southlake, Texas; Amadeus CRS, provided by Amadeus IT Holding S.A. of Madrid, Spain; Worldspan and Apollo CRS, both provided by Travelport Limited of Atlanta, Georgia; and the like.

Airlines commonly use the Airline Tariff Publishing Company of Washington, D.C. to distribute airfares to Computer Reservation Systems across the world. Airlines typically distribute airfares at least once per day, frequently several times daily, or even hourly for some markets.

The pricing volatility and complexity in the airfare market can present challenges for travelers who wish to find the best deal or have the confidence to book early when purchasing air travel, challenges that are multiplied for businesses that purchase air travel in large quantities.

### BRIEF DESCRIPTION OF THE DRAWINGS

FIG. 1 illustrates a simplified airfare price-monitoring system in which price-monitoring server, CRS Server, travel-agent device, and passenger device are connected to a network.

FIG. 2 illustrates several components of an exemplary price-monitoring server.

FIG. 3 illustrates a simplified sequence of communications among price-monitoring server, CRS Server, and travel-agent device in an exemplary, simplified price-monitoring scenario, in accordance with one embodiment.

FIG. 4 illustrates a simplified conceptual model of a flight PNR, in accordance with one embodiment.

FIG. 5 illustrates a routine for importing a Flight PNR into a price-monitoring system, such as may be performed by price-monitoring server in accordance with one embodiment.

FIG. 6 illustrates a subroutine for extracting one or more ticket-monitor records from a given Flight PNR (and associated metadata), such as may be performed by price-monitoring server in accordance with one embodiment.

FIG. 7 illustrates a routine for monitoring the price of a given ticket-monitor record, such as may be performed by price-monitoring server in accordance with one embodiment.

FIG. 8 illustrates a subroutine for checking up-to-date pricing for flight segment(s) represented in a given ticket-monitor record, such as may be performed by price-monitoring server in accordance with one embodiment.

FIG. 9 illustrates a subroutine for identifying flight segment group in a given Flight PNR, such as may be performed by a price-monitoring server in accordance with one embodiment.

FIG. 10 illustrates a subroutine for determining ticket pricing attributes corresponding to a given flight segment group, such as may be performed by a price-monitoring server in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

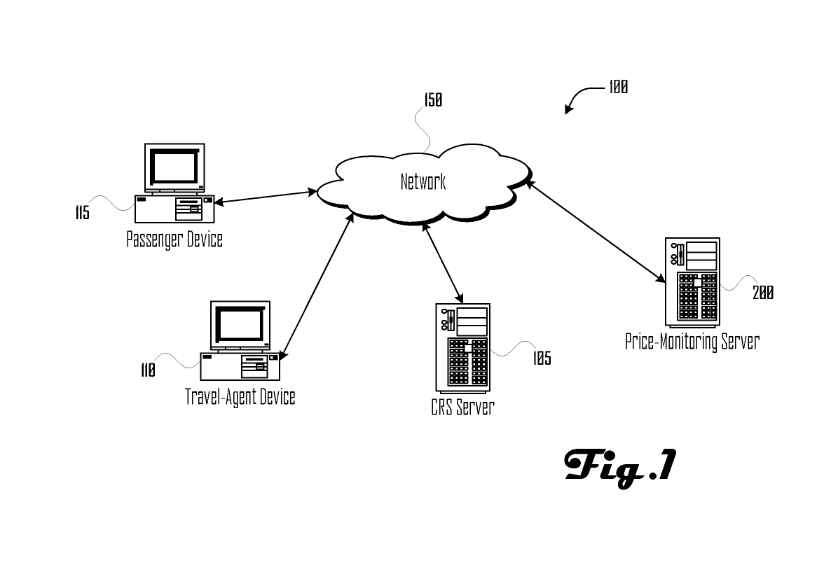

FIG. 1 illustrates a simplified airfare price-monitoring system in which price-monitoring server 200, CRS Server 105, travel-agent device 110, and passenger device 115 are connected to network 150. In an exemplary scenario, an individual or entity that operates passenger device 115 may engage the travel agency that operates travel-agent device 110 to purchase flights and/or other travel services via CRS Server 105. Either the passenger, an entity associated with the passenger (e.g., the passenger's employer), or the travel agency may engage a price monitoring service that operates price-monitoring server 200 to monitor post-purchase price changes for savings opportunities. In some embodiments, price-monitoring server 200 may also be operated by the travel agency.

In various embodiments, network 150 may include the Internet, a local area network (“LAN”), a wide area network (“WAN”), and/or other data network.

In various embodiments, additional infrastructure (e.g., cell sites, routers, gateways, firewalls, and the like), as well as additional devices (e.g., devices operated by airlines) may be present. Further, in some embodiments, the functions described as being provided by some or all of price-monitoring server 200, CRS Server 105, travel-agent device 110, and/or passenger device 115 may be implemented via various combinations of physical and/or logical devices. However, it is not necessary to show such infrastructure and implementation details in FIG. 1 in order to describe an illustrative embodiment.

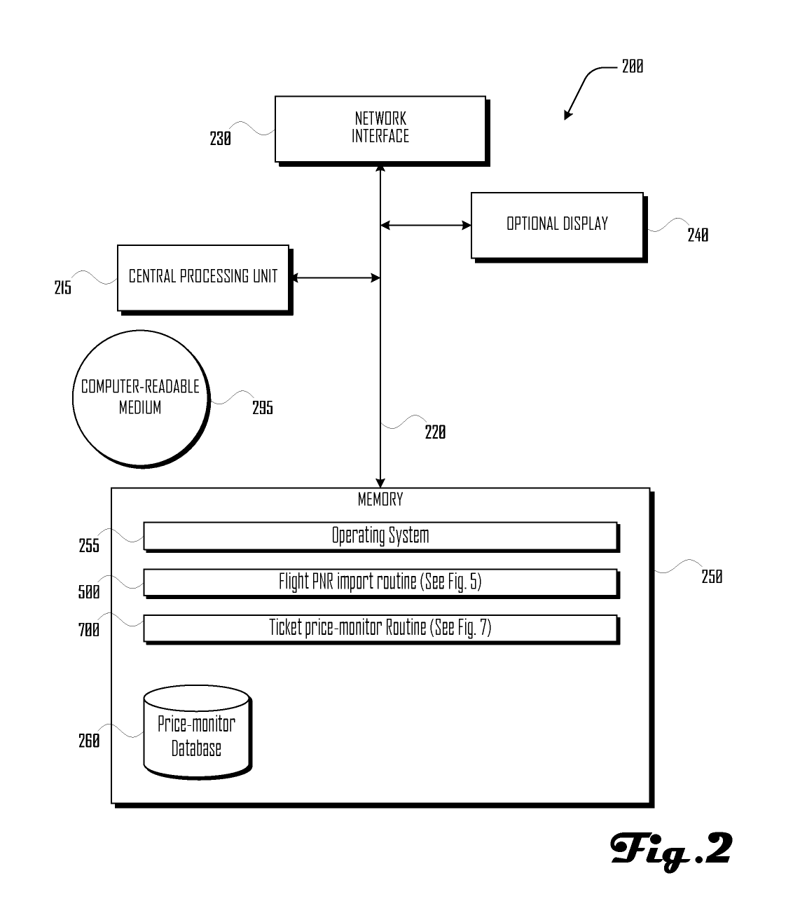

FIG. 2 illustrates several components of an exemplary price-monitoring server 200. In some embodiments, price-monitoring server 200 may include many more components than those shown in FIG. 2. However, it is not necessary that all of these generally conventional components be shown in order to disclose an illustrative embodiment. As shown in FIG. 2, price-monitoring server 200 includes a data network interface 230 for connecting to data network 150.

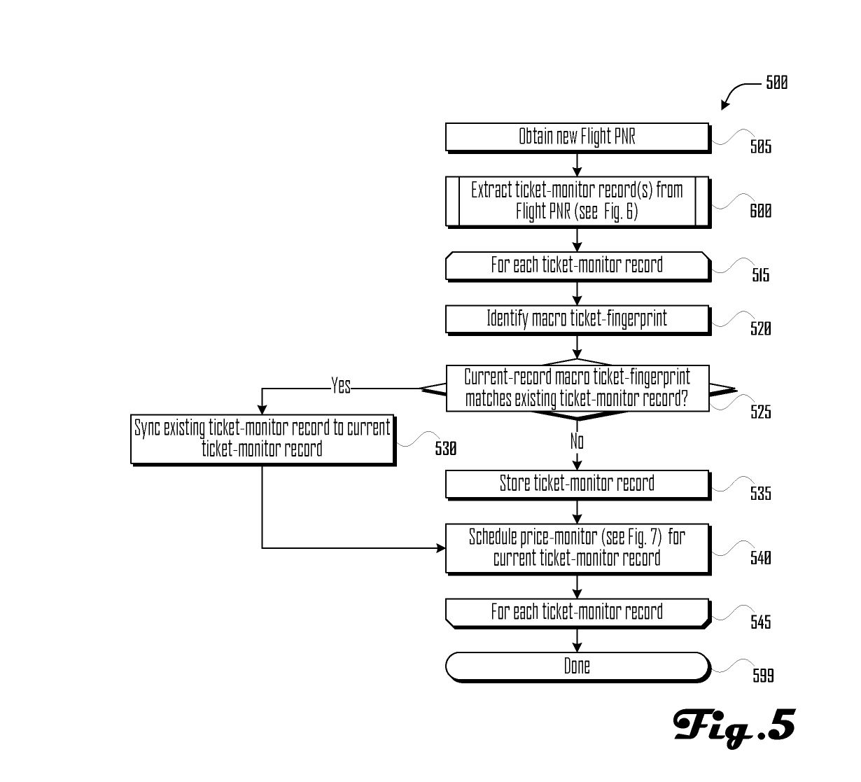

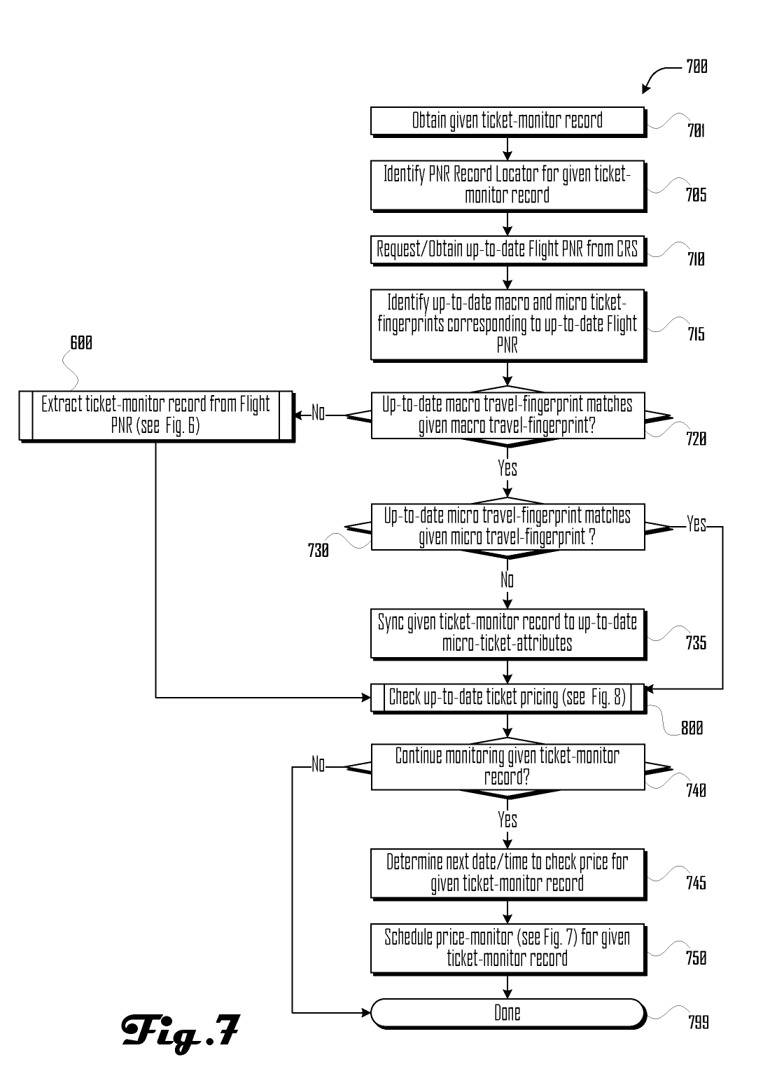

Price-monitoring server 200 also includes a processing unit 215, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for routine 500 for importing a Flight PNR into a price-monitoring system (see FIG. 5) and routine 700 for monitoring the price of a given ticket-monitor record (see FIG. 7).

In addition, the memory 250 also stores an operating system 255 and price-monitor database 260 (or routines for access to an external database). These and other software components may be loaded from a non-transitory computer readable storage medium 295 into memory 250 of the price-monitoring server 200 using a drive mechanism (not shown) associated with a non-transitory computer readable storage medium 295, such as a floppy disc, tape, DVD/CD-ROM drive, flash card, memory card, or the like. In some embodiments, software components may also be loaded via the network interface 230, rather than via a computer readable storage medium 295.

Although price-monitoring server 200 has been described as a conventional computing device, in other embodiments, price-monitoring server 200 may include other computing devices capable of communicating with data network 150, for example, a mobile phone, an tablet, a set-top box, or other like device.

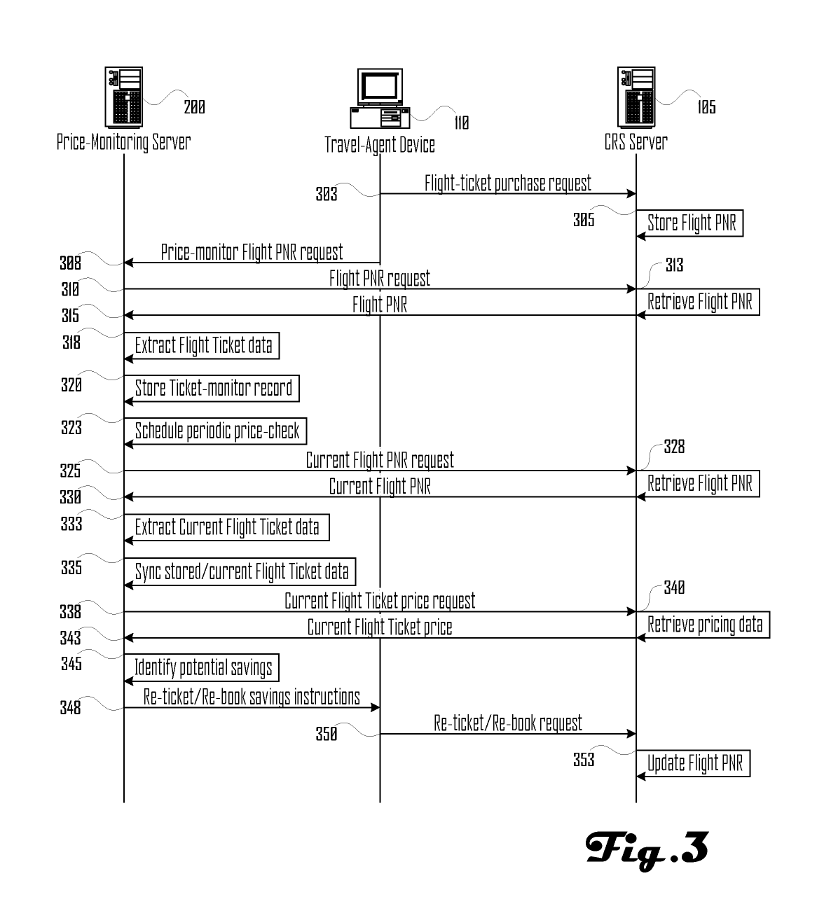

FIG. 3 illustrates a simplified sequence of communications among price-monitoring server 200, CRS Server 105, and travel-agent device 110 in an exemplary, simplified price-monitoring scenario, in accordance with one embodiment. Beginning the exemplary scenario, travel-agent device 110 sends to CRS Server 105 a request 303 to purchase a flight ticket for a given passenger (not shown).

CRS Server 105 processes the request and stores a Passenger Name Record (“PNR”) 305 corresponding to the purchased flight. A PNR is a record stored in the database of a computer reservation system (CRS) that contains data related to an itinerary for a passenger or a group of passengers traveling together.

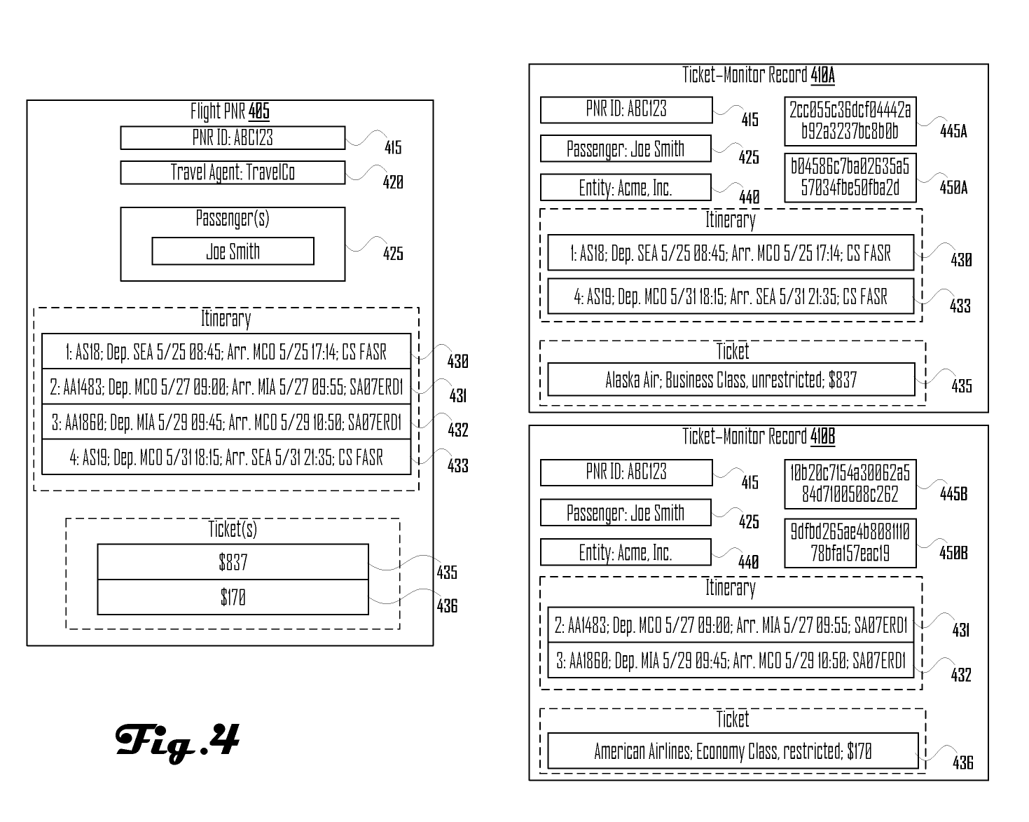

For example, FIG. 4 illustrates a simplified conceptual model of a flight PNR 405, in accordance with one embodiment. While each CRS system maintains its own standard for the content and structure of a PNR, in general, a PNR (e.g., PNR 405) includes at least the following information:
name(s) of the passenger(s) (e.g., name 425);
a booking-agent identifier and/or contact information, which may include a “pseudo city code” (“PCC”) associated with the booking agent (e.g., travel-agent identifier 420);
ticket details (e.g., airline, price, and the like) (e.g., ticket details 435-36); and
an itinerary for one or more flight segments (common to all passengers listed) (e.g., flight segments 430-33, including for each flight segment, a “fare basis code” specifying fare class and restrictions).

A PNR is also associated with an identifier (e.g., identifier 415), usually referred to as a “Record Locator”. Although PNR Record Locators are re-used after the listed itinerary has been completed, PNR Record Locators uniquely identify only one PNR at any given point in time. In practice, PNRs may also include many additional pieces of information, such as passenger demographic data, special requirements, and free-form remarks.

Referring again to FIG. 3, having booked the flight (see request 303, discussed above), travel-agent device 110 communicates a request 308 to price-monitoring server 200 to perform post-purchase price monitoring for tickets corresponding to the newly created Flight PNR. In various embodiments, request 308 may be communicated via various channels, including via an application programming interface (“API”) provided by price-monitoring server 200, by placing the Flight PNR into a CRS queue, provided by CRS Server 105, that is periodically monitored by price-monitoring server 200, and/or by placing the Flight PNR into an other itinerary management queue (not shown) that is periodically monitored by price-monitoring server 200 for PNRs queued by travel-agent device 110.

Either in response to request 308 or during periodic queue monitoring, price-monitoring server 200 sends to CRS Server 105 a request 310 for Flight PNR 305. CRS Server 105 retrieves 313 the Flight PNR and sends the PNR 315 to price-monitoring server 200.

Price-monitoring server 200 extracts ticket data 318 for one or more tickets detailed in the Flight PNR and stores the extracted data to a ticket-monitor record 320.

For example, FIG. 4 also illustrates simplified conceptual models of a ticket-monitor records 410A-B extracted from flight PNR 405, in accordance with one embodiment. Ticket-monitor record 410A corresponds to ticket 435 and flight segments 430 and 433. Ticket-monitor record 410B corresponds to ticket 436 and flight segments 431-32. Ticket-monitor records 410A-B are discussed further below.

Referring again to FIG. 3, having stored at least one ticket-monitor record, price-monitoring server 200 initiates a schedule 323 for price-checking the ticket-monitor record. In some embodiments, the price-checking schedule may begin immediately (as one or more hours may have already passed since the ticket was booked).

Beginning the price-checking process, price-monitoring server 200 requests the Flight PNR in its current form from CRS Server 105. In some embodiments, it may be desirable to obtain the Flight PNR in its current form because the PNR could have been modified since price-monitoring server 200 extracted the data for the ticket-monitor record. For example, the passenger may have re-booked to a different flight, the airline may have changed the departure time or the flight number, the passenger may have canceled the travel altogether, or some other entity may have initiated other like changes.

CRS Server 105 retrieves 328 the current Flight PNR and sends the PNR 330 to price-monitoring server 200. Price-monitoring server 200 extracts current ticket data 333 for the tickets detailed in the ticket-monitor record. If the current ticket data differs from the ticket-monitor record, price-monitoring server 200 updates 335 the ticket-monitor record to reflect the currently extracted data.

Price-monitoring server 200 then sends to CRS Server 105 a request 338 for current pricing data for the purchased ticket. CRS Server 105 retrieves 340 the current pricing data and sends the current pricing data 343 to price-monitoring server 200. Price-monitoring server 200 compares the purchase price to the current pricing data to identify potential savings 345, considering airline change fees (which may vary by airline, origin and destination of flights on the PNR, and fare rules of the ticket) and other transaction fees that may be imposed to re-ticket or re-book the flight.

If potential savings are identified, price-monitoring server 200 communicates re-ticket or re-book instructions 348 to travel-agent device 110. In various embodiments, instructions 348 may be communicated via various channels, including by inserting remarks into the Flight PNR and placing the Flight PNR into a CRS queue, provided by CRS Server 105, the CRS queue being periodically monitored by travel-agent device 110 for PNRs queued by price-monitoring server 200. In some embodiments, price-monitoring server 200 may select among two or more prioritized queues, depending on the urgency and/or importance of the identified potential savings. In other embodiments, price-monitoring server 200 may encode an “urgency” attribute into the Flight PNR before placing it into a CRS queue, such that travel-agent device 110 may be able to query the CRS queue according to “urgency” attributes to identify prioritized Flight PNRs.

Upon receiving the re-ticket or re-book instructions (and if a travel agent chooses to take advantage of the saving opportunity), travel-agent device 110 sends to CRS Server 105 a request 350 to re-ticket or re-book the flight. In response, CRS Server 105 updates 353 the Flight PNR to reflect the current re-ticketed or re-booked flight data.

FIG. 5 illustrates a routine 500 for importing a Flight PNR into a price-monitoring system, such as may be performed by price-monitoring server 200 in accordance with one embodiment. In block 505, routine 500 obtains a new Flight PNR. Typically, the new Flight PNR describes an itinerary that was recently booked by a travel agent (identified in the Flight PNR), which made the Flight PNR available to routine 500. In one embodiment, the travel agent may make the Flight PNR available by placing it in a queue provided for this purpose by a computer reservation system and monitored by routine 500. Thus, in one embodiment, routine 500 may obtain the Flight PNR by requesting it from CRS Server 105.

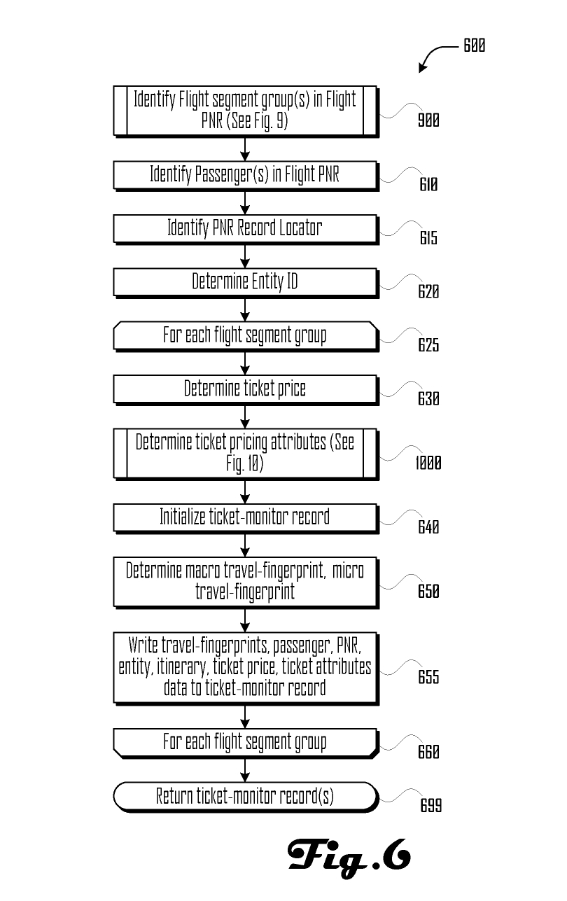

In subroutine block 600 (see FIG. 6, discussed below), routine 500 extracts one or more ticket-monitor records (see, e.g., records 410A-B) from the Flight PNR obtained in block 505. As discussed above, a Flight PNR can contain information for one or more passengers and one or more flight tickets, each ticket being associated with one or more flight segments. By contrast, a ticket-monitor record corresponds to exactly one flight ticket (which is associated with one or more flight segments). In one embodiment, a ticket-monitor record also corresponds to exactly one passenger (i.e., one flight ticket and one passenger), although in alternate embodiments, a ticket-monitor record could be adapted to include multiple passengers on the single flight ticket.

Beginning in opening loop block 515, routine 500 processes each of the one or more ticket-monitor records extracted from the Flight PNR. In block 520, routine 500 identifies a “macro” ticket-fingerprint comprising a set of attributes that identify the flight ticket in question. (See discussion of fingerprint attributes below in reference to blocks 650 and 655 of FIG. 6.) As mentioned above, PNRs can change for many reasons, and such a macro ticket-fingerprint may be useful to distinguish changes that are significant for price-monitoring purposes (e.g., a change to a different airline, a different arrival and/or departure date, a different passenger, a different origin and/or destination, and the like) from PNR changes that are less significant for price-monitoring purposes (e.g., a change to a flight number, arrival and/or departure time, and the like). For example, in one embodiment, a macro ticket-fingerprint for ticket-monitor record 410A may indicate that passenger Smith of Acme, Inc. is traveling from Seattle to Orlando on Alaska Airlines on May 25. Or conversely, any PNR indicating that passenger Smith of Acme, Inc. is traveling from Seattle to Orlando on Alaska Airlines on May 25 should correspond to ticket-monitor record 410A, regardless of details that may be changed by the airline, such as flight number, arrival and/or departure times, and the like.

In some embodiments, the ticket attributes that make up a macro ticket-fingerprint of a ticket-monitor record may be encoded into a form that facilitates search, comparison, and/or storage efficiency, such as a message digest or “hash” computed using a cryptographic hash function, such as MD5, MD6, SHA-0, SHA-1 SHA-2, SHA-3, or the like. (See, e.g., fingerprint hashes 445A-B, 450A-B in records 410A-B.)

Using the macro ticket-fingerprint identified in block 520, routine 500 determines whether the ticket-monitor record currently being processed (extracted from the Flight PNR obtained in block 505) matches an existing ticket-monitor record in a price-monitor database (e.g., database 260). Using ticket-monitor record 410A as an example, routine 500 queries a price-monitor database to determine whether the price-monitor system already has a ticket-monitor record corresponding to passenger Smith of Acme, Inc. traveling from Seattle to Orlando on Alaska Airlines on May 25. In one embodiment, this query may comprise determining whether a record in the database has a fingerprint hash that matches fingerprint hash 445A.

If in decision block 525, routine 500 determines that the ticket-monitor record currently being processed matches an existing ticket-monitor record stored in a price-monitor database, then in block 530, routine 500 updates the existing ticket-monitor record so that its flight details (e.g., flight numbers, departure and/or arrival times, and the like) and purchase details match the data extracted from the Flight PNR obtained in block 505. Additionally, if the Flight PNR had been re-ticketed or re-booked as a result of a previously identified savings opportunity, the current ticket price may be determined to be lower than the previous purchase price. In some embodiments, the difference in price may be recorded as realized savings and the current ticket price added to the ticket-monitor record as the baseline price for future price-checks.

Otherwise, if the ticket-monitor record currently being processed does not match an existing ticket-monitor record, then in block 535, routine 500 stores the ticket-monitor record to the price-monitor database (e.g., database 260).

In block 540, routine 500 schedules an invocation of routine 700 (see FIG. 7, discussed below) to monitor the price of the ticket-monitor record. In some embodiments, routine 500 may schedule an immediate invocation of routine 700. In other embodiments, routine 500 may schedule an invocation of routine 700 at some point in the future (e.g., one hour, four hours, 24 hours, or the like). In some embodiments, routine 500 may also set a date and/or time to stop monitoring the ticket-monitor record (e.g., at or shortly before the departure date and/or time).

In closing loop block 545, routine 500 iterates back to block 515 to process the next ticket-monitor record (if any). Once all ticket-monitor records have been processed, routine 500 ends in block 599.

FIG. 6 illustrates a subroutine 600 for extracting one or more ticket-monitor records from a given Flight PNR (and associated metadata), such as may be performed by price-monitoring server 200 in accordance with one embodiment.

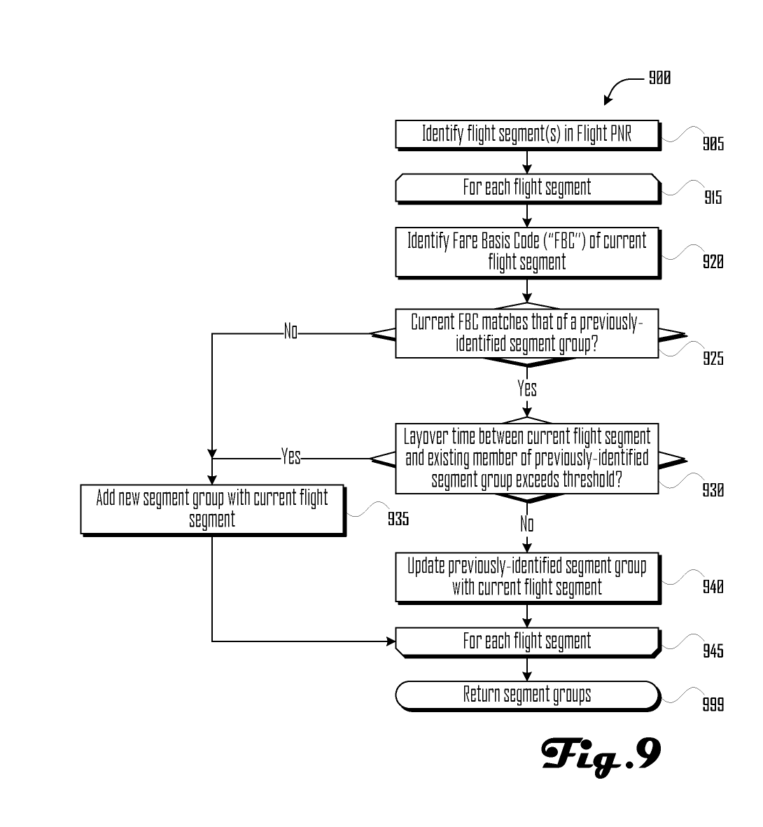

In subroutine block 900, subroutine 600 calls subroutine 900 (see FIG. 9, discussed below) to identify one or more flight tickets in the given flight PNR. For example, if given Flight PNR 405 (see FIG. 4, discussed above), subroutine 600 may identify a first segment group including flight segments 430 and 433 and a second segment group including flight segments 431-32.

In block 610, subroutine 600 identifies one or more passengers in the given flight PNR. For example, if given Flight PNR 405, subroutine 600 may identify passenger 425. Generally, such passenger data is apparent from the PNR data.

In block 615, subroutine 600 identifies a record locator or other identifier identifying the given flight PNR. For example, if given Flight PNR 405, subroutine 600 may identify record locator 415. Generally, such passenger data is apparent from the PNR data.

In block 620, subroutine 600 determines an entity identifier identifying an entity associated with the passenger(s) identified in block 610. Typically, the entity may be a company that employs the passenger(s) and/or that has engaged the flight-price monitoring service that operates the device performing subroutine 600. In some embodiments, such an entity identifier may be apparent from the PNR data. However, in other embodiments, an entity identifier may be determined based on other metadata associated with the given Flight PNR. For example, in one embodiment, an entity identifier may be determinable based on PNR data such as a PCC or other data identifying a booking agent (e.g., identifier 420) in combination with an identifier identifying the CRS queue into which the given Flight PNR was placed by the booking agent.

More particularly, a CRS may provide several numbered queues (e.g., queue nos. 1-99) into which booking agents can place PNRs to provide those PNRs to a price-monitoring service. The price-monitoring service and a given booking agent may agree to use particular queues for PNRs purchased by particular entities. For example, a booking agent may use queue no. 1 for PNRs purchased by Acme, Inc.; queue no. 2 for PNRs purchased by Computer Co.; and so on. A PNR generally includes a PCC or other data identifying a booking agent (e.g., identifier 420), and subroutine 600 may have access to data identifying the queue in which the given Flight PNR was provided. Thus, in such an embodiment, subroutine 600 may consult a lookup table or other data structure to map a booking-agent/queue no. pair to an entity identifier, such as entity identifier 440.

Beginning in opening loop block 625, subroutine 600 processes each flight ticket identified in subroutine block 900. In block 630, subroutine 600 determines the price of the current flight ticket. Generally, the ticket price is apparent from the PNR data, as are certain ticket attributes, frequently including the airline and a fare class (e.g., “F” and “P” for first class and first class premium, “C” and “J” for business and business premium, “Y” for economy/coach, and so on).

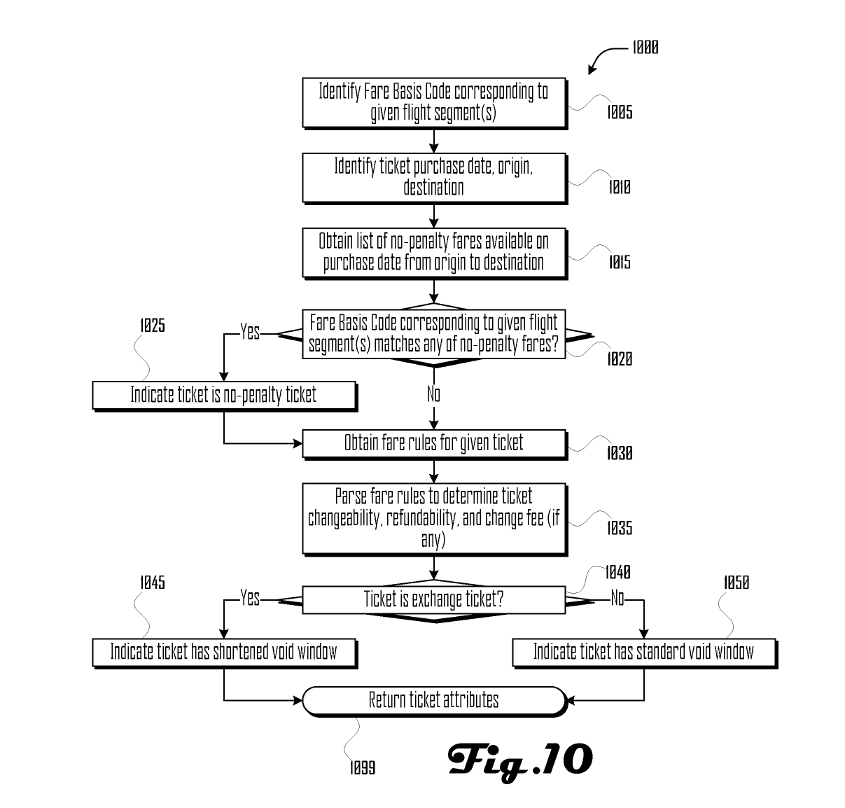

In subroutine block 1000, subroutine 600 calls subroutine 1000 (see FIG. 10, discussed below) to determine additional ticket pricing attributes, such as penalty, changeability, refundability, change fee, and/or void window statuses. In alternate embodiments, instead of or in addition to calling subroutine 1000, subroutine 600 may obtain some or all such ticket attributes by consulting a table including data such as that shown in Table 1, which maps airline/fare-class pairs to ticket attributes such as cabin class and whether the airline imposes a change fee or other penalty for re-ticketing or re-booking the flight.

TABLE 1
Airline/Fare class attribute lookup

| airline_id | fare_class | cabin_class_id | is_penalty |
|---|---|---|---|
| 1 | A | 4 | 1 |
| 1 | B | 1 | 1 |
| 1 | C | 3 | 1 |
| 1 | D | 3 | 1 |
| 1 | E | 1 | 1 |
| 1 | F | 4 | 0 |

In block 640, subroutine 600 initializes a data structure for a ticket-monitor record. In some embodiments, such a ticket-monitor “record” may comprise one or more records in one or more database tables of a price-monitor database (e.g., database 260) determined according to accepted database design principles. Nonetheless, for explanatory purposes, such a collection of related records is referred to herein simply as a ticket-monitor record.

In block 640, subroutine 600 determines “macro” and “micro” travel-fingerprints characterizing the current flight ticket. As discussed above, PNRs can change for many reasons, and ticket-fingerprints may be useful to distinguish changes that are significant for price-monitoring purposes (e.g., a change to a different airline, a different arrival and/or departure date, a different passenger, a different origin and/or destination, and the like) from PNR changes that are less significant for price-monitoring purposes (e.g., a change to a flight number, arrival and/or departure time, and the like) from changes that are insignificant for price-monitoring purposes (e.g., passenger contact or demographic details, special requests, and the like).

To that end, in one embodiment, a macro travel fingerprint may be sensitive to changes to the passenger's identity, the entity (e.g., employer) associated with the passenger, and some or all of the following data points for each flight segment:
Airline (e.g., Alaska Airlines);
Origination (e.g., Seattle);
Destination (e.g., Orlando);
Departure date (e.g., May 25, 2012); and
Arrival date (e.g., May 25, 2012).

Similarly, in one embodiment, a micro travel-fingerprint may be sensitive to changes to all of the data points included in the macro travel-fingerprint, as well as some or all of the following data points for each flight segment:
Flight number (e.g., 18);
Departure time (e.g., 08:45); and
Arrival time (e.g., 17:14).

In some embodiments, standardized International Air Transport Association (“IATA”) codes may be used to represent appropriate flight-segment data points (e.g., two-digit IATA airline designators may represent the airline and/or three-digit airport codes may represent the points of origination and/or destination).

In some embodiments the passenger's identity may be represented by only the passenger's last name, or the passenger's last name and first initial, because it is not uncommon for a PNR to refer at various times to different version of the passenger's first name (e.g., “Tom” vs. “Thomas”).

In some embodiments the entity's identity may be represented by a code or identifier assigned to the entity by the booking agent and/or the price-monitoring service (e.g., entity ID “DEF345”).

In various embodiments, the data comprising a macro or micro travel-fingerprint may be stored in various ways. For example, in one embodiment, the data points comprising a travel-fingerprint may be normalized and concatenated to a single string (e.g. “SMITH DEF345 AK SEA MCO 20120525 20120525 AK MCO SEA 20120531 20120531” for an exemplary macro travel-fingerprint) or block of data and encoded into a form that facilitates search, comparison, and/or storage efficiency, such as a message digest or “hash” (e.g., hashes 445A-B, 450A-B). In various embodiments, a hash may be computed using any suitable cryptographic hash function, such as MD5, MD6, SHA-0, SHA-1 SHA-2, SHA-3, or the like.

In other embodiments, a travel-fingerprint may be represented by literal data structures, such as a concatenated string (e.g. “SMITH DEF345 AK SEA MCO 20120525 20120525 AK MCO SEA 20120531 20120531” for an exemplary macro travel-fingerprint) or a series of structured data fields or key/value pairs (e.g., {“Name”:“SMITH”, “Entity”:“DEF345”, “Airline”:“AK” . . . 1).

In block 655, the ticket-monitor record is populated at least in part with data collected in blocks 900, 610, 615, 620, 630, 1000, and 650. In closing loop block 660, subroutine 600 iterates back to block 625 to process the next flight ticket (if any). Once all flight segment groups have been processed, subroutine 600 ends in block 699, returning the ticket-monitor record(s) to the caller.

FIG. 7 illustrates a routine 700 for monitoring the price of a given ticket-monitor record, such as may be performed by price-monitoring server 200 in accordance with one embodiment. In various embodiments, routine 700 may be invoked for a given ticket-monitor record according to a fixed or variable periodic schedule.

In block 701, routine 700 obtains from a price-monitor database (e.g., database 260) the given ticket-monitor record, representing the flight ticket whose price is to be monitored. In block 705, routine 700 identifies the PNR corresponding to the given ticket-monitor record (e.g., by retrieving the PNR's Record Locator from the ticket-monitor record).

In block 710, routine 700 requests and obtains the up-to-date or “master” version of the Flight PNR from a computerized reservations system (e.g., the system that operates CRS device 105).

Having obtained the up-to-date Flight PNR, in block 715, routine 700 identifies up-to-date macro and micro travel-fingerprints based on data extracted from the up-to-date Flight PNR. For example, in one embodiment, routine 700 may employ a process similar to that shown in FIG. 6 and described above to obtain the up-to-date macro and micro travel-fingerprints.

In decision block 720, routine 700 determines whether the up-to-date macro travel-fingerprint matches the macro travel-fingerprint associated with the given ticket-monitor record. If the macro travel-fingerprints do not match, then a significant change has occurred to the Flight PNR since the given ticket-monitor record was extracted, and routine 700 will cease to monitor the given ticket-monitor record. Rather, in subroutine block 600, routine 700 extracts an up-to-date ticket-monitor record from the up-to-date Flight PNR and proceeds to subroutine block 800 (discussed below) to continue processing the new up-to-date ticket-monitor record.

On the other hand, if in decision block 720, routine 700 determines that the macro travel-fingerprints do match, then the up-to-date Flight PNR has not significantly changed for price-monitoring purposes since the given ticket-monitor record was extracted, and in decision block 730, routine 700 determines whether the up-to-date micro travel-fingerprint matches the micro travel-fingerprint associated with the given ticket-monitor record. If the micro travel-fingerprints do not match, then a detail change has occurred to the Flight PNR since the given ticket-monitor record was extracted, and in block 735, routine 700 updates the given ticket-monitor record to match the details represented in the up-to-date Flight PNR.

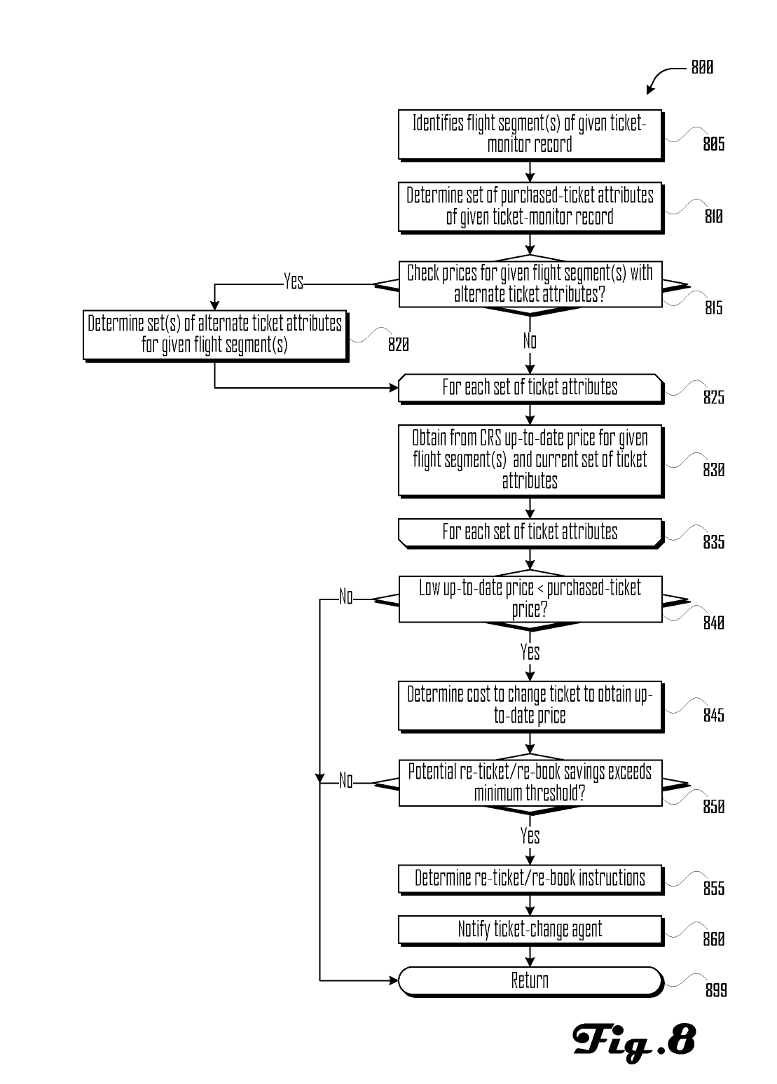

Once the given ticket-monitor record matches all macro and micro fingerprint attributes of the up-to-date Flight PNR, then in subroutine block 800 (see FIG. 8, discussed below), routine 700 checks up-to-date pricing for the flight segment(s) represented in the ticket-monitor record.

In decision block 740, routine 700 determines whether to continue price-monitoring the ticket-monitor record. For example, in some embodiments, the schedule may have a pre-determined end point past which the ticket-monitor record need not be monitored. In other embodiments, routine 700 may dynamically determine whether future favorable price changes are unlikely (e.g., because the departure time is imminent) to determine whether to continue price-monitoring the ticket-monitor record. If routine 700 determines not to continue monitoring the ticket-monitor record, then routine 700 ends in block 799.

On the other hand, if routine 700 determines to continue monitoring the ticket-monitor record, then in block 745, routine 700 determines a next date and/or time to check the price for the ticket-monitor record. In some embodiments, routine 700 may simply determine to schedule the next price-check on a fixed schedule or after a fixed period of time (e.g., after 4, 6, 8, or 24 hours, or another period of time). In such fixed-schedule embodiments, the price-checks for a given ticket-monitor record may be determined in advance and pre-scheduled using job scheduler and/or workload automation software, such as cron, launchd, Windows Task Scheduler, or other like utility.

In other embodiments, routine 700 may determine a dynamic schedule based on expected price volatility. For example, in one embodiment, flight prices may generally be the most volatile during a period between 7-30 days prior to departure, and consequently, routine 700 may schedule price checks more frequently (e.g., every four hours) during periods of expected high volatility and less frequently (e.g., once per day) during periods of expected low volatility. Computerized reservations systems typically charge a small fee (on the order of a few pennies) for obtaining current ticket prices, so routine 700 may dynamically adjust the schedule to minimize incurring costs that are unlikely to lead to cost savings.

In block 750, routine 700 schedules a price-check for the ticket-monitor record at the next date and/or time determined in block 745 (although, as discussed above, in some fixed-schedule embodiments, the price-checks for a given ticket-monitor record may be determined in advance and pre-scheduled using job scheduler and/or workload automation software). Routine 700 ends in block 799.

FIG. 8 illustrates a subroutine 800 for checking up-to-date pricing for flight segment(s) represented in a given ticket-monitor record, such as may be performed by price-monitoring server 200 in accordance with one embodiment. In block 805, subroutine 800 identifies one or more flight segments represented by the given ticket-monitor record. For example, if given ticket-monitor record 410A, subroutine 800 may identify flight segments 430 and 433.

In block 810, subroutine 800 determines a set of one or more purchased-ticket attributes associated with the flight ticket represented by the given ticket-monitor record (e.g., ticket 435). (See, e.g., fare-class ticket-attributes discussed in respect of FIG. 6, above, and FIG. 10, below.)

In decision block 815, subroutine 800 determines whether to check up-to-date prices for tickets having alternate attributes for the given flight segment(s). If so, then in block 820, subroutine 800 determines a set of one or more alternate ticket attributes that would be acceptable substitutes for the purchased-ticket in the current context.

For example, in one embodiment, if the purchased ticket is in a business-class fare class, subroutine 800 would not determine to check prices for economy-class tickets because an economy-class ticket is not an acceptable substitute for a business class ticket. For another example, if the purchased ticket is unrestricted (e.g., no Saturday night stay is required), subroutine 800 would not determine to check prices for restricted tickets (e.g., those that require a Saturday night stay).

On the other hand, in some contexts, subroutine 800 may determine that alternate ticket attributes would be acceptable substitutes for the purchased ticket. For example, in some cases, the purchased ticket was purchased far in advance and has attributes that it is fully refundable and/or has no “change” penalty (e.g., does not require an additional fee to re-ticket or re-book). However, if it is currently only a few days prior to departure, subroutine 800 may determine that an otherwise identical ticket that is nonrefundable and/or that has a change penalty would be an acceptable substitute (as the travel is unlikely to be canceled or changed so close to the departure). In some embodiments, the threshold within which a change-penalty ticket would be considered an acceptable substitute for a no-change-penalty ticket may be specified by the entity that engaged the price-monitoring service.

Beginning in opening loop block 825, subroutine 800 iterates over each set of acceptable ticket attributes that it has determined to price-check (the purchased-ticket attributes set determined in block 810 and any alternate attribute sets that were determined in block 820).

In block 830, subroutine 800 requests and obtains an up-to-date price for the given flight segment(s) and the current set of ticket attributes from a computerized reservations system (e.g., the system that operates CRS device 105).

In closing loop block 835, subroutine 800 iterates back to block 825 to process the next set of acceptable ticket-attributes (if any).

In block 840, subroutine 800 determines whether it obtained an up-to-date price for a ticket with acceptable ticket attributes that is lower than the purchased-price for the given ticket-monitor record. If not, then routine 800 ends in block 899.

On the other hand, if subroutine 800 obtained an up-to-date for an identical or acceptable-substitute flight ticket, then in block 845, subroutine 800 determines how much it would cost to re-ticket or re-book the flight ticket to obtain the up-to-date (lower) pricing. In some embodiments, subroutine 800 may obtain re-ticket/re-book costs by consulting previously identified ticket attributes (see FIG. 10, discussed below). In alternate embodiments, subroutine 800 may obtain re-ticket/re-book costs by consulting a table including data such as that shown in Table 2, which maps ticket-change fees and ticket-cancel fees by airline, region or origin, and region of destination. For example, according to Table 2, for an American Airlines flight within the northeast region of the United States, the cost to change or cancel a ticket is $275.

TABLE 2
Change and Cancel fees by airline and region

| | origin- | destination- | change- | cancel- | cancel- |
|---|---|---|---|---|---|
| airline-code | region | region | fee | window | fee |
| AA | US-NE | US-NE | $275 | 0 | $275 |
| UA | US-NE | US-NE | $250 | 0 | $250 |
| DL | US-NE | US-NE | $250 | 0 | $250 |
| B6 | US-NE | US-NE | $0 | 0 | $0 |
| US | US-NE | US-NE | $250 | 0 | $250 |

Using such ticket-change fee and ticket-cancel fee data, subroutine 800 can determine the cost to re-ticket or re-book the flight ticket to obtain the up-to-date (lower) pricing. In decision block 850, subroutine 800 determines whether the potential savings exceeds a predetermined threshold for the entity associated with the flight ticket. For example, if the up-to-date price for a given ticket is $500, the purchased price is $800, and the change/cancel fee is $275, then the potential savings is only $25 ($800 less the sum of $500 and $275). If the entity associated with the flight ticket (e.g., the employer of the passenger) has specified that it only wishes to capture savings that exceed $100, then subroutine 800 would determine that the potential savings do not exceed the minimum threshold, and routine 800 would end in block 899.

Conversely, if the up-to-date price for a given ticket is $500, the purchased price is $1000, and the change/cancel fee is $275, then the potential savings is $225, and subroutine 800 may determine to proceed to block 855 to determine re-ticket/re-book instructions for capturing the savings that has been identified. For example, in one embodiment, subroutine 800 may assemble an instruction string instructing a travel agent to cancel the purchased ticket and purchase a specific new ticket at the up-to-date price or to change the purchased ticket to the specific new ticket.

In block 860, subroutine 800 notifies an agent of the potential savings. For example, in one embodiment, subroutine 800 may insert the instruction string determined in block 855 into a remarks field of the Flight PNR associated with the given ticket-monitor record, and submit the altered Flight PNR into a CRS queue provided by the computer reservation system and monitored by a travel agent who can act on the instructions. In some embodiments, subroutine 800 may select among two or more prioritized queues, depending on the urgency and/or importance of the identified potential savings. In other embodiments, subroutine 800 may encode an “urgency” attribute into the Flight PNR before placing it into a CRS queue, such that a travel agent may be able to query the CRS queue according to “urgency” attributes to identify prioritized Flight PNRs. In other embodiments, subroutine 800 may alert a travel agent of the potential savings (and instructions) via another communication channel, such as an email, instant message, or other like channel.

In alternate embodiments, subroutine 800 may call a re-ticket/re-book routine (not shown) to automatically capture the potential savings if the circumstances warrant. Having identified potential savings and instructed a ticket-change agent on how to capture the potential savings, subroutine 800 ends in block 899.

FIG. 9 illustrates a subroutine 900 for identifying flight segment group(s) in a given Flight PNR, such as may be performed by a price-monitoring server 200 in accordance with one embodiment.

In block 905, subroutine 900 identifies one or more flight segments in the given Flight PNR. For example, if given Flight PNR 405 (see FIG. 4, discussed above), subroutine 900 may identify flight segments 430-33.

Beginning in opening loop block 915, subroutine 900 processes each flight segment in turn. In block 920, subroutine 900 identifies a fare basis code corresponding to the current flight segment. For example, when processing flight segment 430 or 433 of 410A ticket-monitor record, subroutine 900 may identify the fare basis code “CS FASR”, whereas when processing flight segment 431-32 of 410B ticket-monitor record, subroutine 900 may identify the fare basis code “SA07ERD1. Generally speaking, such fare basis codes may encode meaning that may be understood by a travel agent and/or a specific air carrier. However, in some embodiments, fare basis codes may be treated by subroutine 900 simply as strings that may be compared to one another without regard to their encoded meanings.

In decision block 925, subroutine 900 determines whether the fare basis code of the current flight segment matches a fare basis code associated with any flight segment group that may have been identified in a previous iteration. If so, then subroutine 900 proceeds to decision block 930. Otherwise, subroutine 900 proceeds to block 935.

In decision block 930, subroutine 900 determines whether there is a layover (i.e., time spent at a terminal after departing one plane and waiting to board the next) between the current flight segment and any flight segment that is a member of the flight segment group matched in decision block 925, and if there is such a layover, whether the time spent waiting to board the next flight exceeds a predetermined threshold (e.g., 8 to 12 hours).

If so, then subroutine 900 proceeds to block 935 as when a layover exceeding such a threshold exists, then the current flight segment may not belong to the flight segment group matched in decision block 925, notwithstanding the identical fare basis codes. Otherwise, subroutine 900 proceeds to block 940.

In block 935, subroutine 900 creates a new segment group including the current flight segment. In block 940, subroutine 900 updates the flight segment group matched in decision block 925 such that it includes the current flight segment.

In ending loop block 945, subroutine 900 iterates back to opening loop block 915 to process the next flight segment, if any. Once all flight segments have been processed, subroutine 900 ends in ending block 999, returning the identified flight segment group(s) to the caller.

FIG. 10 illustrates a subroutine 1000 for determining ticket pricing attributes corresponding to a given flight segment group, such as may be performed by a price-monitoring server 200 in accordance with one embodiment.

In block 1005, subroutine 1000 identifies a fare basis code corresponding to the given flight segment group. For example, when processing flight segment 430 or 433 of 410A ticket-monitor record, subroutine 1000 may identify the fare basis code “CS FASR”, whereas when processing flight segment 431-32 of 410B ticket-monitor record, subroutine 1000 may identify the fare basis code “SA07ERD1”. Generally speaking, such fare basis codes may encode meaning that may be understood by a travel agent and/or a specific air carrier. However, in some embodiments, fare basis codes may be treated by subroutine 1000 simply as strings that may be compared to one another without regard to their encoded meanings.

In block 1010, subroutine 1000 identifies basic ticket attributes corresponding to the given flight segment group, including a ticket purchase date, a flight origin, and a flight destination.

In block 1015, subroutine 1000 obtains from a CRS a list of no-penalty fares that were available on the ticket purchase date between the flight origin and the flight destination as determined in block 1010.

In decision block 1020, subroutine 1000 determines whether the fare basis code identified in block 1005 matches a fare basis code associated with any of the no-penalty fares (as obtained in block 1015).

If so, then subroutine 1000 proceeds to block 1025. Otherwise, subroutine 1000 proceeds to block 1030.

In block 1025, subroutine 1000 stores an indication that the ticket corresponding to the given flight segment group is a no-penalty ticket.

In block 1030, subroutine 1000 obtains (e.g., from a CRS) one or more fare rules corresponding to the ticket. In some embodiments, the fare rules thereby obtained may take the form of a block of human-readable (if jargon-filled) text.

In block 1035, subroutine 1000 parses the fare rules (as obtained in block 1030) to determine such ticket attributes as whether the ticket is changeable or non-changeable, and if it is changeable, then what the change fee (if any) would be for changing to a different fare, and whether a change to a lower fare would result in a refund or a credit (in which case, the ticket would be considered to be refundable), or a forfeit of the difference between the original fare and the changed lower fare. In some embodiments, a natural language processing toolkit may be employed to parse the fare rules.

In decision block 1040, subroutine 1000 determines whether the ticket corresponding to the given flight segment group is an exchange ticket (e.g., whether the ticket in question was previously re-booked or re-ticketed). In some embodiments, a coupon status attribute of the ticket may be consulted when determining whether the ticket is an exchange ticket.

If so, then subroutine 1000 proceeds to block 1045. Otherwise, subroutine 1000 proceeds to block 1050.

In block 1045, subroutine 1000 stores an indication that the ticket has a shortened void window (the period of time during which the ticket may be canceled without penalty). For example, in the Sabre Global Distribution System in North America, in the case of an exchange ticket, the shortened void window typically expires at 23:59CST the same day as the ticket was purchased. Other CRS/GDS systems and/or other regions may have different shortened void windows.

In block 1050, subroutine 1000 stores an indication that the ticket has a standard void window. For example, in the Sabre Global Distribution System in North America, the standard void window typically expires at 23:59CST the day after the ticket was purchased. Other CRS/GDS systems and/or other regions may have different standard void windows.

In ending block 1099, subroutine 1000 returning the determined ticket attributes to the caller.

Although specific embodiments have been illustrated and described herein, it will be appreciated by those of ordinary skill in the art that a whole variety of alternate and/or equivalent implementations may be substituted for the specific embodiments shown and described without departing from the scope of the present disclosure. This application is intended to cover any such adaptations or variations of the embodiments discussed herein.

1. A price-monitoring-server-implemented method for monitoring a flight-ticket price, the method comprising:
obtaining, by the price-monitoring server via a travel-agent device, a request to monitor prices associated with a previously-booked flight itinerary;
obtaining, by the price-monitoring server from a computerized reservations system (“CRS”), an itinerary record corresponding to said flight itinerary;
identifying, by the price-monitoring server, a plurality of flight segments indicated by said itinerary record;
grouping, by the price-monitoring server, one or more of said plurality of flight segments into a flight-segment group for which a flight ticket was previously purchased;
determining, by the price-monitoring server based at least in part on said itinerary record, metadata associated with said flight-segment group, said segment-group-associated metadata including a passenger surname, a purchase price, a purchase date, and an entity identifier identifying an entity on whose behalf said previously-purchased flight ticket was purchased;
generating, by the price-monitoring server, a macro ticket fingerprint based at least in part on macro metadata including said passenger surname, said entity identifier, and metadata associated with each flight segment of said flight-segment group, said segment-associated metadata including a plurality of data items selected from an airline identifier, a flight origin identifier, a flight destination identifier, a departure date, and an arrival date;
determining, by the price-monitoring server, a change-penalty status associated with said previously-purchased flight ticket;
inserting or updating a ticket-monitor record, identified according to said macro ticket fingerprint, in a data store such that said ticket-monitor record comprises said segment-associated metadata, said segment-group-associated metadata, and said macro ticket fingerprint;
determining, by the price-monitoring server, a price-monitoring schedule based at least in part on said segment-associated metadata; and
periodically monitoring, by the price-monitoring server, prices associated with said previously-purchased flight ticket;
wherein at least one price-monitoring period comprises:
obtaining, by the price-monitoring server, an up-to-date version of said itinerary record from said CRS;
generating, by the price-monitoring server, an up-to-date macro ticket fingerprint according to metadata extracted from said up-to-date version of said itinerary record;
verifying, by the price-monitoring server according to said macro ticket fingerprint of said ticket-monitor record and said up-to-date macro ticket fingerprint, that since said ticket-monitor record was inserted or updated, no significant change has occurred to said previously-purchased flight ticket;
obtaining, by the price-monitoring server, current pricing data associated with said previously-purchased flight ticket according to said segment-associated metadata of said ticket-monitor record; and
determining, by the price-monitoring server based at least in part on said current pricing data, said purchase price, and said change-penalty status, that a cost saving is currently obtainable by re-ticketing or re-booking said plurality of flight segments.

2. The method of claim 1, wherein said at least one price-monitoring period further comprises:
assembling agent instructions instructing a travel agent how to capture said cost saving; and
providing said agent instructions to said travel-agent device.

3. The method of claim 2, wherein providing said agent instructions to said travel-agent device comprises:
inserting said agent instructions into said itinerary record; and
placing said itinerary record, with said agent instructions inserted therein, in a CRS queue periodically monitored by said travel agent.

4. The method of claim 1, wherein grouping said one or more of said plurality of flight segments into said flight-segment group comprises:
identifying a plurality of fare basis codes respectively associated with said plurality of flight segments; and
determining that said one or more of said plurality of flight segments have identical fare basis codes.

5. The method of claim 4, wherein grouping said one or more of said plurality of flight segments into said flight-segment group further comprises determining that said one or more of said plurality of flight segments with identical fare basis codes are not separated by a layover exceeding a predetermined threshold.

6. The method of claim 1, wherein determining said change-penalty status comprises:
identifying a fare basis code associated with said previously-purchased flight ticket;
obtaining, from said CRS based at least in part on some or all of said segment-associated metadata, a plurality of no-penalty fare basis codes,
determining that said previously-purchased flight ticket has no change penalty when said fare basis code matches one of said plurality of no-penalty fare basis codes.

7. The method of claim 1, wherein determining said change-penalty status comprises:
obtaining, from said CRS based at least in part on some or all of said segment-associated metadata, a plurality of fare rules; and
parsing said plurality of fare rules to determine whether a fare associated with said previously-purchased flight ticket is or is not changeable.

8. The method of claim 7, wherein determining said change-penalty status further comprises:
parsing said plurality of fare rules to determine whether a refund or a credit may be obtained when said previously-purchased flight ticket is re-ticketed or re-booked at a price that is lower than said purchase price.

9. The method of claim 7, wherein determining said change-penalty status further comprises:
parsing said plurality of fare rules to determine a change fee associated with re-ticketing or re-booking said previously-purchased flight ticket.

10. The method of claim 1, wherein determining said change-penalty status comprises identifying a void window during which period of time said previously-purchased flight ticket may be canceled with no penalty.

11. The method of claim 10, wherein identifying said void window comprises determining whether said previously-purchased flight ticket is an exchange ticket.

12. The method of claim 1, wherein at least one price-monitoring period comprises:
determining an expected price-volatility metric based at least in part on said departure date; and
adjusting said price-monitoring schedule based at least in part on said expected price-volatility metric.

13. The method of claim 1, further comprising:
determining, based at least in part on said itinerary record, additional metadata associated with said previously-purchased flight ticket, said additional metadata including a flight number, a departure time, and an arrival time;
generating, based at least in part on said segment-associated metadata and said additional metadata, a micro ticket fingerprint that identifies said previously-purchased flight ticket; and
wherein said ticket-monitor record further comprises said micro ticket fingerprint.

14. The method of claim 13, wherein said at least one price-monitoring period comprises:
generating an up-to-date micro ticket fingerprint according to metadata extracted from said up-to-date version of said itinerary record;
determining, according to said micro ticket fingerprint of said ticket-monitor record and said up-to-date micro ticket fingerprint, that since said ticket-monitor record was inserted or updated, a detail change has occurred to said previously-purchased flight ticket; and
synchronizing said ticket-monitor record according to said detail change.

15. The method of claim 1, wherein said itinerary record comprises a Passenger Name Record.

16. The method of claim 1, wherein said segment-associated metadata excludes a flight number, a departure time, and an arrival time for each flight segment of said flight-segment group.

17. A computing apparatus comprising a processor and a memory having stored thereon instructions that when executed by the processor, configure the apparatus to perform a method for monitoring a flight-ticket price, the method comprising:
obtaining, via a travel-agent device, a request to monitor prices associated with a previously-booked flight itinerary;
obtaining, from a computerized reservations system (“CRS”), an itinerary record corresponding to said flight itinerary;
identifying a plurality of flight segments indicated by said itinerary record;
grouping one or more of said plurality of flight segments into a flight-segment group for which a flight ticket was previously purchased;
determining, based at least in part on said itinerary record, metadata associated with said flight-segment group, said segment-group-associated metadata including a passenger surname, a purchase price, a purchase date, and an entity identifier identifying an entity on whose behalf said previously-purchased flight ticket was purchased;
generating a macro ticket fingerprint based at least in part on macro metadata including said passenger surname, said entity identifier, and metadata associated with each flight segment of said flight-segment group, said segment-associated metadata including a plurality of data items selected from an airline identifier, a flight origin identifier, a flight destination identifier, a departure date, and an arrival date;
determining a change-penalty status associated with said previously-purchased flight ticket;
inserting or updating a ticket-monitor record, identified according to said macro ticket fingerprint, in a data store such that said ticket-monitor record comprises said segment-associated metadata, said segment-group-associated metadata, and said macro ticket fingerprint;
determining a price-monitoring schedule based at least in part on said segment-associated metadata; and
periodically monitoring prices associated with said previously-purchased flight ticket;
wherein at least one price-monitoring period comprises:
obtaining an up-to-date version of said itinerary record from said CRS;
generating an up-to-date macro ticket fingerprint according to metadata extracted from said up-to-date version of said itinerary record;
verifying, according to said macro ticket fingerprint of said ticket-monitor record and said up-to-date macro ticket fingerprint, that since said ticket-monitor record was inserted or updated, no significant change has occurred to said previously-purchased flight ticket;
obtaining current pricing data associated with said previously-purchased flight ticket according to said segment-associated metadata of said ticket-monitor record; and
determining, based at least in part on said current pricing data, said purchase price, and said change-penalty status, that a cost saving is currently obtainable by re-ticketing or re-booking said plurality of flight segments.

18. The apparatus of claim 17, wherein said at least one price-monitoring period further comprises:
assembling agent instructions instructing a travel agent how to capture said cost saving; and
providing said agent instructions to said travel-agent device.

19. A non-transient computer-readable storage medium having stored thereon instructions that when executed by a processor, configure the processor to perform a method for monitoring a flight-ticket price, the method comprising:
obtaining, via a travel-agent device, a request to monitor prices associated with a previously-booked flight itinerary;
obtaining, from a computerized reservations system (“CRS”), an itinerary record corresponding to said flight itinerary;
identifying a plurality of flight segments indicated by said itinerary record;
grouping one or more of said plurality of flight segments into a flight-segment group for which a flight ticket was previously purchased;
determining, based at least in part on said itinerary record, metadata associated with said flight-segment group, said segment-group-associated metadata including a passenger surname, a purchase price, a purchase date, and an entity identifier identifying an entity on whose behalf said previously-purchased flight ticket was purchased;
generating a macro ticket fingerprint based at least in part on macro metadata including said passenger surname, said entity identifier, and metadata associated with each flight segment of said flight-segment group, said segment-associated metadata including a plurality of data items selected from an airline identifier, a flight origin identifier, a flight destination identifier, a departure date, and an arrival date;
determining a change-penalty status associated with said previously-purchased flight ticket;
inserting or updating a ticket-monitor record, identified according to said macro ticket fingerprint, in a data store such that said ticket-monitor record comprises said segment-associated metadata, said segment-group-associated metadata, and said macro ticket fingerprint;
determining a price-monitoring schedule based at least in part on said segment-associated metadata; and
periodically monitoring prices associated with said previously-purchased flight ticket;
wherein at least one price-monitoring period comprises:
obtaining an up-to-date version of said itinerary record from said CRS;
generating an up-to-date macro ticket fingerprint according to metadata extracted from said up-to-date version of said itinerary record;
verifying, according to said macro ticket fingerprint of said ticket-monitor record and said up-to-date macro ticket fingerprint, that since said ticket-monitor record was inserted or updated, no significant change has occurred to said previously-purchased flight ticket;
obtaining current pricing data associated with said previously-purchased flight ticket according to said segment-associated metadata of said ticket-monitor record; and
determining, based at least in part on said current pricing data, said purchase price, and said change-penalty status, that a cost saving is currently obtainable by re-ticketing or re-booking said plurality of flight segments.

20. The storage medium of claim 19, wherein said at least one price-monitoring period further comprises:
assembling agent instructions instructing a travel agent how to capture said cost saving; and
providing said agent instructions to said travel-agent device.
